(19) United States
(12) Patent Application Publication
(10) Pub. No.: US 2012/0222625 A1
(43) Pub. Date: Sep. 6, 2012

(54) ANIMAL WATER BOTTLE CAP DISPENSER DEVICE

(76) Inventor: Hope Adams, New York, NY (US)

(21) Appl. No.: 13/469,086

(22) Filed: May 10, 2012

Related U.S. Application Data
(63) Continuation of application No. 12/715,059, filed on Mar. 1, 2010.

(51) Int. Cl. A01K 7/00

(52) U.S. Cl. 119/72

(57) ABSTRACT

The present invention is an animal and pet water bottle cap dispenser device, used in combination with a water bottle with a bottle top to dispense water to an animal or pet. The device has a flanged attachment sleeve, a flanged vertical middle sleeve and a dispersion ball that is set on the top surface of the vertical middle sleeve as water from the bottle runs internally through the sleeves and around the sides of the dispersion ball to the animal or pet to disperse drinking. There is also a second cap that is threadedly and removably integral with the middle sleeve, to cover the dispersion ball and the device, while the device is not in use. The device can be easily disassembled, separated, sterilized, sanitized and reassembled for sterilized or sanitary pet or animal usage, is dishwasher safe and is choke-free.

The present application is a continuation of U. S. Non-Provisional patent application Ser. No. 12/715,059 filed on Mar. 1, 2010 the entire disclosure of which is incorporated by reference.

### TECHNICAL FIELD & BACKGROUND

The present invention generally relates to an animal and pet water bottle cap dispenser device. More specifically, the invention is an animal and pet water bottle cap dispenser device that is more sanitized to safely hydrate an animal or pet.

It is an object of the invention to provide an animal and pet bottle water cap dispenser device that can be easily assembled and disassembled.

It is also an object of the invention to provide an animal and pet water bottle water cap dispenser device that is easy to sterilize and sanitize.

It is also an object of the invention to provide an animal and pet bottle water cap dispenser that has a choke-free design.

What is really needed is an animal and pet water bottle cap dispenser device that has a water dispersing mechanism that bobs and rolls and has a shape that resembles a female animal's udder, so that a pet or animal will gravitate to it.

### BRIEF DESCRIPTION OF THE DRAWINGS

The present invention will be described by way of exemplary embodiments, but not limitations, illustrated in the accompanying drawings in which like references denote similar elements, and in which:

FIG. 1 A illustrates an exploded front perspective view of an animal and pet water bottle cap dispenser device, in accordance with one embodiment of the present invention.

FIG. 1 B is a front side perspective view of an animal and pet water bottle cap dispenser device (without a cap), in accordance with one embodiment of the present invention.

FIG. 2A illustrates a front perspective view of an attachment sleeve component of the animal and pet water bottle cap dispenser device, in accordance with one embodiment of the present invention.

FIG. 2B illustrates a diagonal rear perspective view of an attachment sleeve component of the animal and pet water bottle cap dispenser device, in accordance with one embodiment of the present invention.

FIG. 3A illustrates a front perspective view of a vertical middle sleeve component of the animal and pet water bottle cap dispenser device, in accordance with one embodiment of the present invention.

FIG. 3B illustrates a side perspective view of a vertical middle sleeve component of the animal and pet water bottle cap dispenser device, in accordance with one embodiment of the present invention.

FIG. 4 illustrates a front perspective view of a dispersion ball component of the animal and pet water bottle cap dispenser device, in accordance with one embodiment of the present invention.

FIG. 5A illustrates a side perspective view of a cap component of the animal and pet water bottle cap dispenser device, in accordance with one embodiment of the present invention.

FIG. 5B illustrates a bottom side perspective view of a cap component of the animal and pet water bottle cap dispenser device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

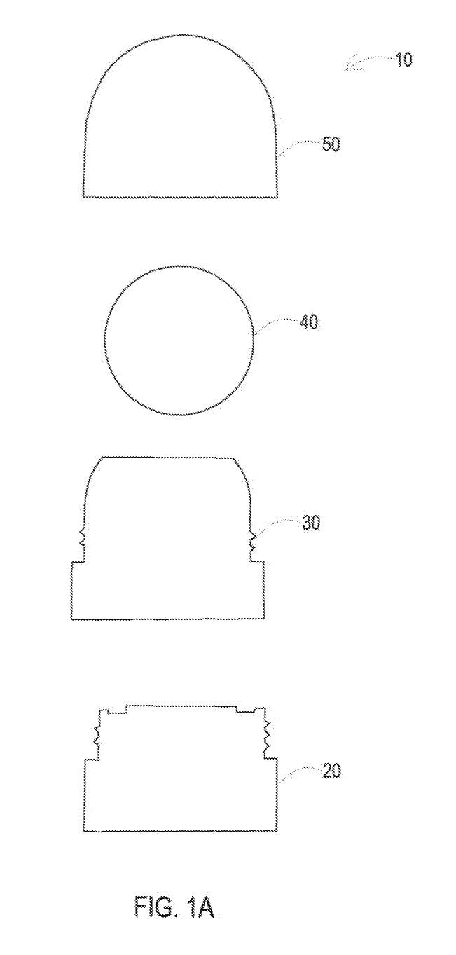

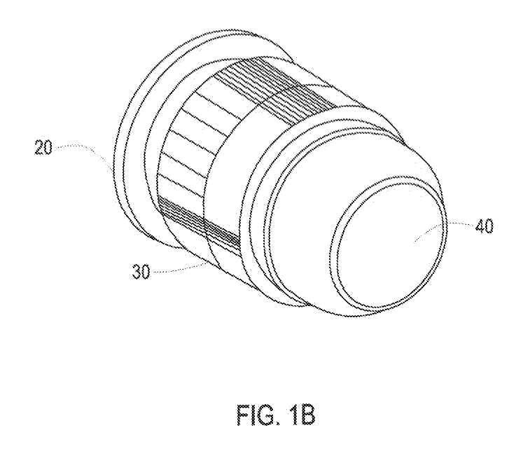

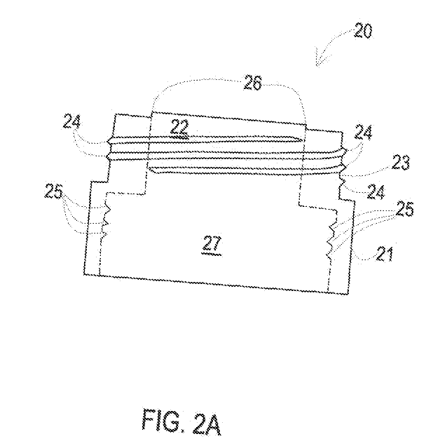

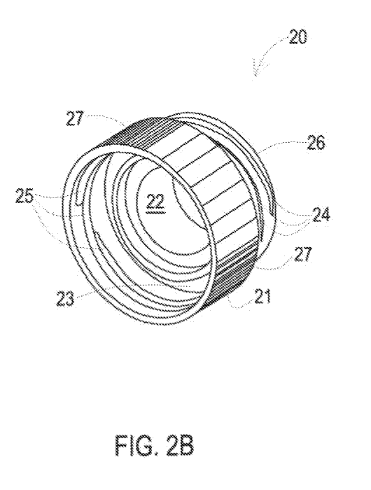

FIG. 1 A is an exploded front perspective view of an animal and pet water bottle cap dispenser device 10, used in combination with an animal or pet water bottle with a bottle top and a plurality of threads (all not shown), to dispense water to an animal or pet (not shown). The animal and pet water bottle cap dispenser device 10 has several major components that include an attachment sleeve 20, a vertical middle sleeve 30, a dispersion ball 40 and a second cap 50, all of which can be easily twisted apart and reassembled for sterilization and/or sanitation. The dispenser device 10 is threadedly and removably attached to the water bottle and the plurality of threads on the water bottle after the bottle top is removed from the water bottle. Details on this attachment is discussed in further detail in the FIG. 2A discussion. Once the 10 bottle top is removed, the dispenser device 10 can be applied to an animal or pet water bottle. Any sanitation method or sterilization method that is well known to those schooled in the art can be used that won't adversely affect the attachment sleeve 20, the vertical middle sleeve 30, the dispersion ball 40 and the second cap 50 of the animal and pet water bottle cap dispenser device 10. The animal 15 and pet water bottle cap dispenser device 1 0 and its major components, the attachment sleeve 20, the vertical middle sleeve 30, the dispersion ball 40 and the second cap 50, are all dishwasher safe as well.

FIG. 1B is front side perspective view of an animal and pet water bottle cap dispenser device 10. FIG. 1B shows an assembled animal and pet water 20 bottle cap dispenser device 10 with an attachment sleeve 20, vertical middle sleeve and dispersion ball 40. No top 50 for the animal and pet water bottle cap dispenser device 10 is shown in FIG. 1B. The animal and pet water bottle cap dispenser device 10 can also be a single piece where the attachment sleeve 20, the vertical middle sleeve 30 and the dispersion ball 40 are permanently attached to prevent an unassembled part from being choked on by an animal. The animal and pet water bottle cap dispenser device 10 is also made of flavored plastic that provides one or more suitable flavors to an animal that licks the animal and pet water bottle cap dispenser device 10.

FIG. 2A is a front perspective view of the attachment sleeve 20 for the animal and pet water bottle cap dispenser device 10. The attachment sleeve 20 has a first flange 21, a protruding internal vertical stand portion 22 and an exterior protruding circular stand 23 with exterior threads 24 set around the protruding interior circular stand 23. There is also a first plurality of interior threads 25 within the first flange 21, a first internal aperture 26 within the internal stand portion 22 and a first plurality of exterior ribbing for gripping 27 outside of the first flange 21. The attachment sleeve 20 can also be easily twisted off and separated from the water bottle and the animal and pet water bottle cap dispenser device 10, when it can then be sanitized and sterilized by any sanitation method or sterilization method that is well known to those schooled in the art that won't adversely affect the attachment sleeve 20. The first plurality of interior threads 25 within the first flange 21 of the attachment sleeve 20 are interlocked with the exterior threads of the water bottle that are exposed (not 15 shown) when the bottle top is removed to securely attach the attachment sleeve 20 and the entire animal and pet water bottle cap dispenser device 10 to the water bottle.

FIG. 2B illustrates a diagonal rear perspective view of an attachment sleeve component 20 of the animal and pet water bottle cap dispenser device 10. 20 FIG. 2B illustrates all the major features of the attachment sleeve 20 as illustrated in FIG. 2A which include the first flange 21, the protruding vertical stand 22, the exterior protruding circular stand 23, the exterior threads around the exterior protruding vertical stand 24, the first plurality of threads 25, the first internal aperture 26 and the first plurality of exterior ribbing for gripping 27.

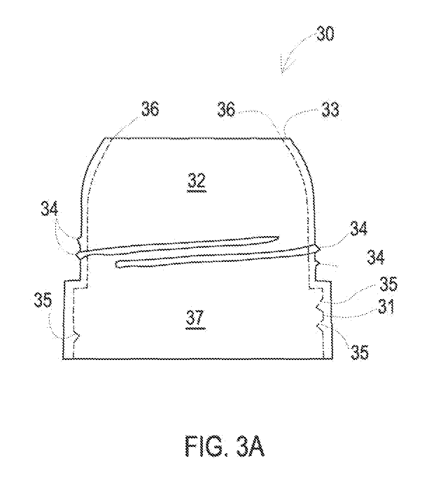

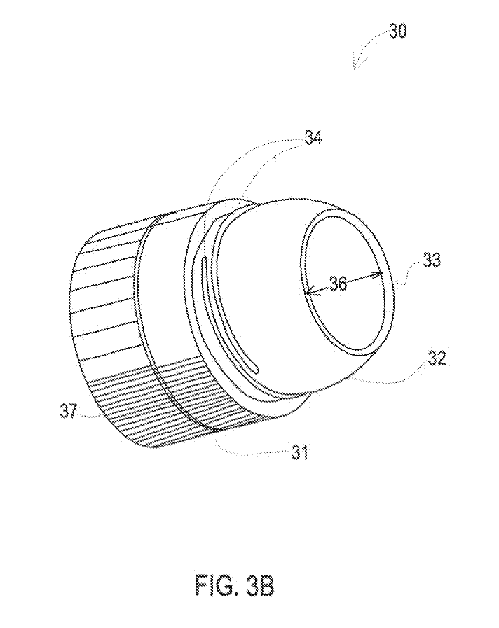

FIG. 3A is a front perspective view of the vertical middle sleeve 30 used as a component of the animal and pet water bottle cap dispenser device 10. The vertical middle sleeve 30 has a second flange 31, a vertically protruding top portion 32 with a top surface 33 and a second plurality of exterior threads 34, a second plurality of internal threads 35 within the second flange 31, a second internal aperture 36 and a second plurality of exterior ribbing for gripping 37 outside of the second flange 31. The second internal threads 35 interlock with the exterior threads 24 of the protruding circular stand 23 of the attachment sleeve 20 to form an attachment that can be released by twisting apart the attachment sleeve 20 and the vertical middle sleeve 30 and separating them as desired. The vertical middle sleeve 30 can also be easily twisted off and separated from the attachment device 20 to then be sanitized and sterilized by any sanitation method or sterilization method that is well known to those schooled in the art that won't adversely affect the vertical middle sleeve 30. The attachment sleeve 20 and vertical middle sleeve 30 can just as easily be reconnected by engaging, twisting and interlocking the second internal threads 35 with the exterior threads 24 of the exterior protruding circular stand 23 in order to removably connect the vertical middle sleeve 30 with the attachment sleeve 20. The protruding vertical stand 22 of the attachment sleeve 20 also extends into the second vertical aperture 36 of the vertical middle sleeve 30 as the attachment sleeve 20 and vertical middle sleeve 30 are being connected. This allows water from the water bottle to run through the first internal aperture 26 while the attachment sleeve 20 and vertical middle sleeve 30 are connected.

FIG. 3B illustrates a side perspective view of a vertical middle sleeve component 30 of the animal and pet water bottle cap dispenser device 10.

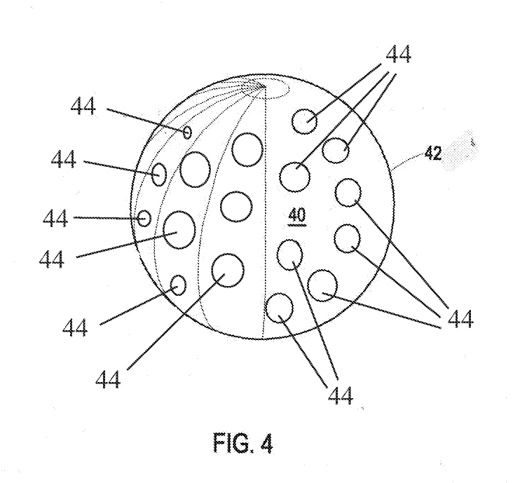

FIG. 3B illustrates every component of the vertical middle sleeve 30 in FIG. 3A, except the second plurality of threads 35, which are not visible in FIG. 3B. All other components of the vertical middle sleeve 30, such as the second flange 31, the vertically protruding top portion 32, the top surface 33, the exterior threads 34, the second internal aperture 36 and the second plurality of exterior ribbing 37 are illustrated in FIG. 38. The vertical middle sleeve 30 and the dispersion ball 40 (described in FIG. 4 description) form a shape that resembles a female animal's udder, so that a pet or animal will gravitate to it.

FIG. 4 illustrates a front perspective view of the dispersion ball 40 used as a component of the animal and pet water bottle cap dispenser device 10. The dispersion ball 40 has an overall spherical surface 42 that is set within the top surface 33 of the vertical middle sleeve 30. The overall spherical surface 42 is covered with a plurality of dimples 44 over the entire overall spherical surface 42. The dimples 44 contain and hold water to be dispersed within allowing water to stay on the dispersion ball 40 for a relatively longer period of time and dispersing a relatively greater amount of water in contrast to a dispersion ball 40 without the dimples 44.

As water runs from the first internal aperture 26 of the attachment sleeve 20, water will trickle through the narrow spacing between the spherical surface 42 of the dispersion ball 40 and the top surface 33 of the vertical middle sleeve 30 for an animal or a pet to drink the dispersed water. The dispersion ball 40 is not permanently attached to the top surface 33 of the vertical middle sleeve 30 and can move and rotate slightly while set on the top surface 33 as water trickles through the narrow spacing between the spherical surface 42 and the top surface 33. The dispersion ball 40 also produces a dispersion effect on the water as opposed to water that would simply flow from the first internal aperture 26 directly to the drinking pet or animal. The dispersion ball 40 also has the ability to bob and roll, while the pet or animal licks the dispersion ball 40 so that when an animal licks the dispersion ball 40, it pushes the dispersion ball 40 upward and then spins to release water. Like all components of the animal and pet water bottle cap dispenser device 10, the dispersion ball 40 can also be removed, sanitized and sterilized by any sanitation method or sterilization method that is well known to those schooled in the art that won't adversely affect the dispersion ball 40. The dispersion ball 40 can never fall out into the pet's or animal's mouth while drinking, because the dispersion ball 40 can't physically fit through the top surface 33 and second internal aperture 36 of the vertical middle sleeve 30, which internally holds the dispersion ball 40. This makes the animal and pet water bottle cap dispenser device 10 100% choke free, since the dispersion ball 40 has no way of being released from the top surface 33 of the vertical middle sleeve 30 while the animal or pet is licking the dispersion ball 40. The difference between this product and other similar products on the market, is its bob and rolls dispersion ball mechanism. It is physically impossible for a pet or animal to choke while drinking with the animal and pet water bottle cap dispenser device 10 because the dispersion ball 40 is locked underneath the vertical middle sleeve 30 and the top surface 33 on top of it. Also the shape of the animal and pet water bottle cap dispenser device 10 is different from any other. This shape resembles the female animal's udder, so pets and animals gravitate to it.

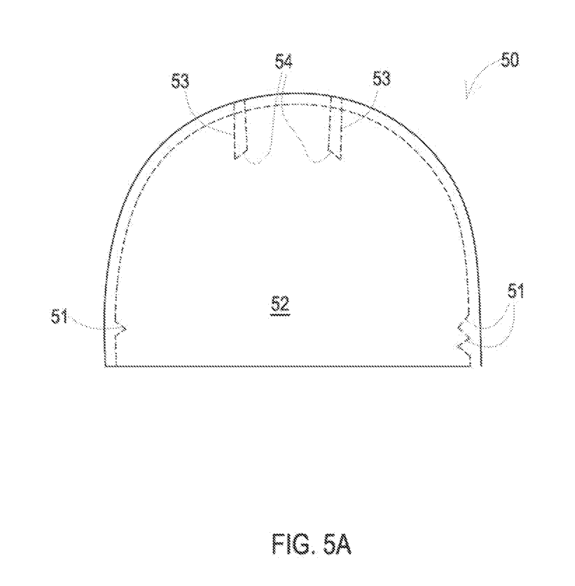

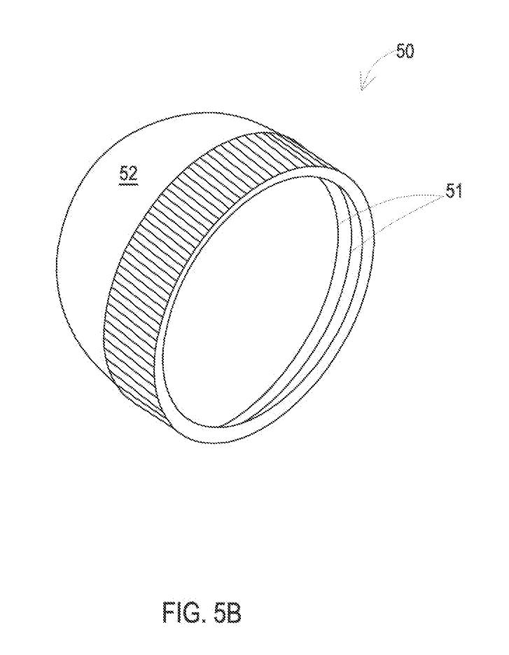

FIG. 5A illustrates a front perspective view of the second cap 50 used as a component of the animal and pet water bottle cap dispenser device 10. The second cap 50 has a third plurality of internal threads 51 within the second cap 50 and a third plurality of exterior ribbing for gripping 52 the second cap 50, that is threadedly and removably integral with the exterior threads 34 of the middle sleeve 30, for covering the dispersion ball 40 and the device 10, while the device 10 is not in use. The second cap 50 also has extending internal prongs 53 that are in contact with the dispersion ball 40 and internally hold the ball 40 in place 10 while the second cap 50 covers the dispersion ball 40. These prongs 53 vertically extend downward and are angled at each tip 54 to better secure the ball 40 in place while the ball 40 is being covered. Like all components of the animal and pet water bottle cap dispenser device 1 0, the second cap 50 can also be removed, sanitized and sterilized by any sanitation method or sterilization method that is well known to those schooled in the art that won't adversely affect the second cap 50.

FIG. 5B illustrates a bottom side perspective view of a cap component 50 of the animal and pet water bottle cap dispenser device 10. FIG. 5B illustrates the second cap 50, the third plurality of internal threads 51 and the third plurality of exterior ribbing for gripping 52. However, FIG. 5B does not illustrate the extending integral prongs 53 and the angled top of the prongs 54, which are illustrated in FIG. 5A. The second cap 50 does allow a pet or animal owner to carry the animal and pet water bottle cap dispenser device 10 without having to worry about water leaking from the animal and pet water bottle cap dispenser device 10, due to the cap 50.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. An animal water bottle cap dispenser device, used in combination with an animal water bottle with a plurality of threads and a bottle top, to dispense water to an animal, comprising:
an attachment sleeve with a first flange, a protruding internal vertical stand, an exterior protruding circular stand with a first plurality of exterior threads set around said protruding circular stand, a first plurality of interior threads within said first flange, a first internal aperture within said internal stand and a first plurality of exterior ribbing to grip outside of said first flange, that threadedly and removably attaches said animal water bottle cap dispenser device to said animal water bottle;
a vertical middle sleeve with a second flange, a vertically protruding top portion with a top surface and a second plurality of exterior threads, a second plurality of internal threads within said second flange, a second internal aperture and a second plurality of exterior ribbing to grip said second flange, that is threadedly and removably integral to said attachment sleeve;
a dispersion ball with an overall spherical surface and a plurality of dimples covering said overall spherical surface, that is set within said top surface as said water runs from said animal water bottle through said first internal aperture and said second internal aperture and between said spherical surface of said dispersion ball and said top surface to said animal to disperse drinking that also bobs and rolls as said animal drinks, said dispersion ball is unable to be released from said vertical middle sleeve forming a choke-free design that is also in a female utter shape, said attachment sleeve, said vertical middle sleeve and said dispersion ball; and
a second cap with a third plurality of internal threads within said second cap and a third plurality of exterior ribbing to grip said second cap, that is threadedly and removably integral with said exterior threads of said vertical middle sleeve, to cover said dispersion ball and said animal water bottle cap dispenser device, said animal water bottle cap dispenser device is sanitized in a dishwasher.

2. The animal water bottle cap dispenser device according to claim 1, wherein said animal water bottle cap dispenser device is threadedly and removably attached to said water bottle after said bottle top is removed from said water bottle.

3. The animal water bottle cap dispenser device according to claim 1, wherein said animal water bottle cap dispenser device is sterilized in a dishwasher.

4. The animal water bottle cap dispenser device according to claim 1, wherein said animal water bottle cap dispenser device is washed in said dishwasher.

5. The animal water bottle cap dispenser device according to claim 1, wherein said second cap is twisted off and separated from said water bottle.

7. The animal water bottle cap dispenser device according to claim 1, wherein said second cap is sanitized in said dishwasher.

8. The animal water bottle cap dispenser device according to claim 1, wherein said second cap is sterilized in said dishwasher.

9. The animal water bottle cap dispenser device according to claim 1, wherein said second cap is washed in said dishwasher.

10. The animal water bottle cap dispenser device according to claim 1, wherein said second cap has a plurality of extending internal prongs that are in contact with said dispersion ball and internally hold said dispersion ball in place with a plurality of angled tips, while said second cap covers said dispersion ball.

11. An animal water bottle cap dispenser device, used in combination with an animal water bottle with a plurality of threads and a bottle top, to dispense water to an animal, comprising:
an attachment sleeve with a first flange, a protruding internal vertical stand, an exterior protruding circular stand with a first plurality of exterior threads set around said protruding circular stand, a first plurality of interior threads within said first flange, a first internal aperture within said internal stand and a first plurality of exterior ribbing to grip outside of said first flange, that threadedly and removably attaches said animal water bottle cap dispenser device to said animal water bottle;
a vertical middle sleeve with a second flange, a vertically protruding top portion with a top surface and a second plurality of exterior threads, a second plurality of internal threads within said second flange, a second internal aperture and a second plurality of exterior ribbing to grip said second flange, that is threadedly and removably integral to said attachment sleeve;
a dispersion ball with an overall spherical surface and a plurality of dimples covering said overall spherical surface, that is set within said top surface as said water runs from said animal water bottle through said first internal aperture and said second internal aperture and between said spherical surface of said dispersion ball and said top surface to said animal to disperse drinking that also bobs and rolls as said animal drinks, said dispersion ball is unable to be released from said vertical middle sleeve forming a choke-free design that is also in a female utter shape, said attachment sleeve, said vertical middle sleeve and said dispersion ball; and
a second cap with a third plurality of internal threads within said second cap and a third plurality of exterior ribbing to grip said second cap, that is threadedly and removably integral with said exterior threads of said vertical middle sleeve, to cover said dispersion ball and said animal water bottle cap dispenser device, said animal water bottle cap dispenser device is sanitized in a dishwasher.

12. The animal water bottle cap dispenser device according to claim 11, wherein said animal water bottle cap dispenser device is threadedly and removably attached to said water bottle after said bottle top is removed from said water bottle.

13. The animal water bottle cap dispenser device according to claim 11, wherein said animal water bottle cap dispenser device is sterilized in a dishwasher.

14. The animal water bottle cap dispenser device according to claim 11, wherein said animal water bottle cap dispenser device is washed in said dishwasher.

15. The animal water bottle cap dispenser device according to claim 11, wherein said second cap is twisted off and separated from said water bottle.

16. The animal water bottle cap dispenser device according to claim 11, wherein said second cap is sanitized in said dishwasher.

17. The animal water bottle cap dispenser device according to claim 11, wherein said second cap is sterilized in said dishwasher.

18. The animal water bottle cap dispenser device according to claim 11, wherein said second cap is washed in said dishwasher.

19. The animal water bottle cap dispenser device according to claim 11, wherein said second cap has a plurality of extending internal prongs that are in contact with said dispersion ball and internally hold said dispersion ball in place with a plurality of angled tips, while said second cap covers said dispersion ball.

20. The animal water bottle cap dispenser device according to claim 11, wherein said is made of flavored plastic that provides one or more suitable flavors to said animal that licks said animal and pet water bottle cap dispenser device.
